(19) United States
(12) Patent Application Publication
(10) Pub. No.: US 2007/0053454 A1
(43) Pub. Date: Mar. 8, 2007

(54) Compensation method and apparatus in orthogonal frequency division multiplexing (OFDM) systems

(76) Inventors: Manish Bhardwaj, Cambridge, MA (US); Jian Cui, Acton, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/494,282

(22) Filed: Jul. 27, 2006

Related U.S. Application Data
(63) Continuation-in-part of application No. 11/365,957, filed on Feb. 28, 2006.
Application No. 11/365,957 is a continuation of application No. 11/220,356, filed on Aug. 31, 2005.
(60) Provisional application No. 60/605,906, filed on Aug. 31, 2004.

(51) Int. Cl. H04K 1/10

(52) U.S. Cl. 375/260

(57) ABSTRACT

In estimating and compensating impairments of Orthogonal Frequency Division Multiplexing (OFDM) symbols, a first estimation is obtained by evaluating and comparing received training symbols with transmitted training symbols. A second estimation is obtained by evaluating and comparing a first portion of received payload symbols with estimated payload symbols. A final estimation is obtained by combining the first and second estimations. Compensation of a second portion of the payload symbols is obtained by using the final estimation, while compensation of the first portion of the payload symbols is obtained by using the first estimation. The current method and apparatus, ideal for low rate systems, disclosed herein allows for required signal-to-noise ratio (SNR) performance less then 0.2 dB away from the best achievable performance without the introduction of complex or expensive hardware.

### RELATED APPLICATIONS

This application is a continuation-in-part of U.S. application Ser. No. 11/365,957, filed Feb. 28, 2006, which is a continuation of U.S. application Ser. No. 11/220,356, filed Aug. 31, 2005, which claims the benefit of U.S. Provisional Application No. 60/605,906 filed on Aug. 31, 2004. The entire teachings of the above applications are incorporated herein by reference.

### BACKGROUND OF THE INVENTION

Frequency Division Multiplexing (FDM) is a technology, widely used in communication systems, which allows for the transmission of multiple signals simultaneously over a single transmission path. Each signal travels within its own unique frequency range, or carrier, which is modulated by the data (i.e. text, voice, video, etc.) to represent the information being transmitted.

Orthogonal Frequency Division Multiplexing (OFDM) is a technique which distributes data over several carriers that are spaced apart at precise frequencies. This spacing provides the orthogonality in this technique which prevents the demodulators from seeing frequencies other than their own. A few benefits of OFDM are resiliency to RF interference, high spectral efficiency, and lower multi-path distortion. The latter is useful because in a typical terrestrial broadcasting scenario there are multipath-channels (i.e. the transmitted signal arrives at the receiver using various paths of different length). Since multiple versions of the signal interfere with each other, also known as inter symbol interference, it becomes very hard to extract the original information.

The Fast Fourier Transform (FFT) is the building block of OFDM systems. Convention dictates that the input to a FFT is considered time domain and its output frequency domain. All signals prior to undergoing an FFT (time domain signals) are in lowercase. All signals post FFT (frequency domain signals) are uppercase.

An M-point FFT takes m time domain samples and produces M frequency domain samples (sometimes also called frequency domain bins). The subscript in a time variable denotes the sample number. Subscripts in frequency domain denote bin number. Hence, when we say that a 4-point FFT of xₙ produces Xₖ, what we really mean is that the FFT of the four time samples x₀, x₁, x₂, x₃ produces frequency outputs X₀, X₁, X₂ and X₃.

Another subscript is added to specify the OFDM symbol number. Thus, we say the FFT of x_{m,n} produces X_{m,k}. Here x_{m,n} refers to the time samples in the m^{th} OFDM symbol and so on.

Estimates of unknown quantities are denoted by a tick (′). Hence if Hₖ denotes the frequency domain channel, then H′ₖ denotes the estimate of that channel. The objective in estimation is to make the estimate (H′ₖ) as close as possible to the true underlying value (Hₖ). We sometimes drop subscripts in the text. Thus, X′ is simply an abbreviation of X′ₖ or X′_{m,k}.

A typical burst mode OFDM packet structure 101 is shown in FIGS. 1 and 2. The packet 101 is divided into training symbols 103 and payload symbols 105. Training symbols 103 are included at the start of a packet and comprise sub-carriers which are known prior to the transmission of the packet. Sub-carriers consist of data and pilots, wherein the pilots are used as a reference to estimate impairments throughout a packet.

In the training symbols 103, both the data and pilots are known prior to the transmission of the packet, therefore the training symbol may be used as a test reference to determine the loss and noise 109 associated with the transmission channel 107. Following the training symbols 103 in the packet 101, are the payload symbols 105.

The payload symbols 105 comprise data and pilots wherein only the pilots are known prior to the transmission of the packet. The data of the payload symbols 105 is the actual data which is meant to be transmitted. A received packet 111 also comprises received training symbols 113, followed by received payload symbols 115. The transmitted training symbols are denoted by t (T); the transmitted payload is denoted by p (P). The corresponding receive signals are denoted by u (U) and q (Q).

A canonical OFDM receiver 300 is shown in FIG. 3. The receiver 300 comprises a timing and frequency offset correction 303, a Fast Fourier Transform device 305, a channel estimation device 307, a channel compensator 311, a derotation device 313, and a decoder 315. A signal 301 received by a canonical OFDM receiver will typically go through estimation steps to determine loss in relation to timing, frequency offset, rotation, and channel effects. Compensation of the payload symbols are then performed for the impairments discovered in the estimation steps. Finally the compensated data is decoded to yield bits 317. For simplicity, only the estimation step for channel effects 307 and the compensation for channel loss 311 have been shown. It should be appreciated that other estimation and compensation devices may be employed.

Channel estimation is done by dividing the FFT of the received training symbol by the FFT of the known transmitted training symbol:
H′_{n,k}=U_{n,k}/T_{n,k} (1)
As was discussed before, since all of the sub-carriers of the training symbols are known prior to transmission, they provide a very useful estimation of loss in the system. If L training symbols were transmitted, the channel estimate can be improved by averaging; in other words, dividing the sum of all the estimations by the total number of training symbols:

$${H}_{k}^{′} = \frac{1}{L} {\sum }_{n = 1}^{L} {H}_{n , k}^{′} \qquad ( 2 )$$

Compensation of the received signal due to channel effects is achieved by dividing the FFT of the received OFDM symbol by the channel estimate:
Cₖ=Qₖ/H′ₖ (3)
where Cₖ corresponds to OFDM signals that have been compensated for the channel.

### SUMMARY OF THE INVENTION

In a receiving apparatus and method to provide a final estimation of OFDM symbols, a first estimator is used for estimating impairments in a received training symbol. An example of an impairment may be channel loss resulting from a transmission channel. A second estimator is used for estimating impairments in a first portion of a received payload symbol. An updating estimator is also employed for combining the estimations of the first and the second estimators to yield a final estimation. A compensator is used wherein the first portion of the received payload symbol is compensated using an estimation obtained by the first estimator, and a second portion of the received payload symbols is compensated using the final estimation.

An error rate may be dominated by the second portion of the payload symbols may be chosen such that a final SNR performance is less than 0.2 dB from ideal performance. The lowest 802.11 WLAN OFDM rate of 6 Mbps may be employed.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIGS. 1 and 2 are schematics showing the transmission of OFDM symbols;

FIG. 3 is schematic of an OFDM receiver according to the prior art;

FIG. 4 is a packet error rate (PER) vs. signal-to-noise ratio (SNR) plot displaying data from an ideal system, prior art systems, and a system according to an embodiment of the present invention;

FIG. 5 is a schematic showing the division of OFDM symbols according to an aspect of the present invention; and

FIG. 6 is an OFDM receiver according to an aspect of the present invention.

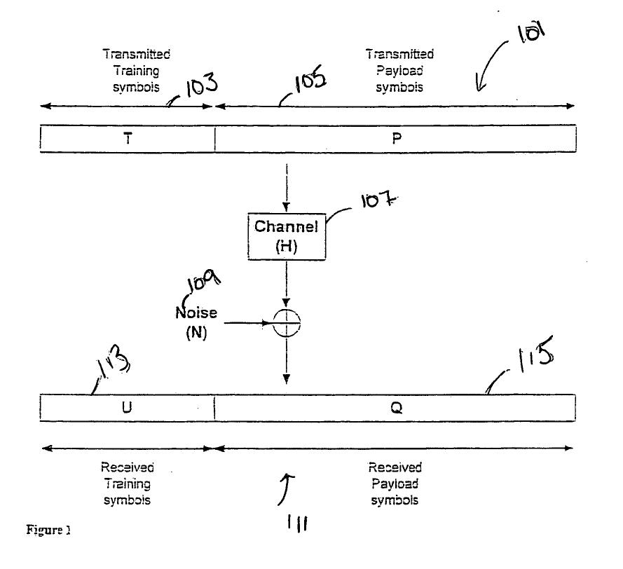

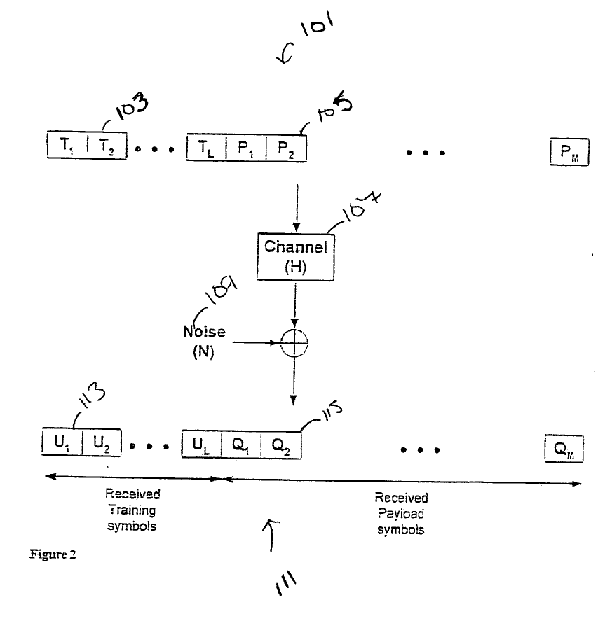

### DETAILED DESCRIPTION OF THE INVENTION

A description of preferred embodiments of the invention follows.

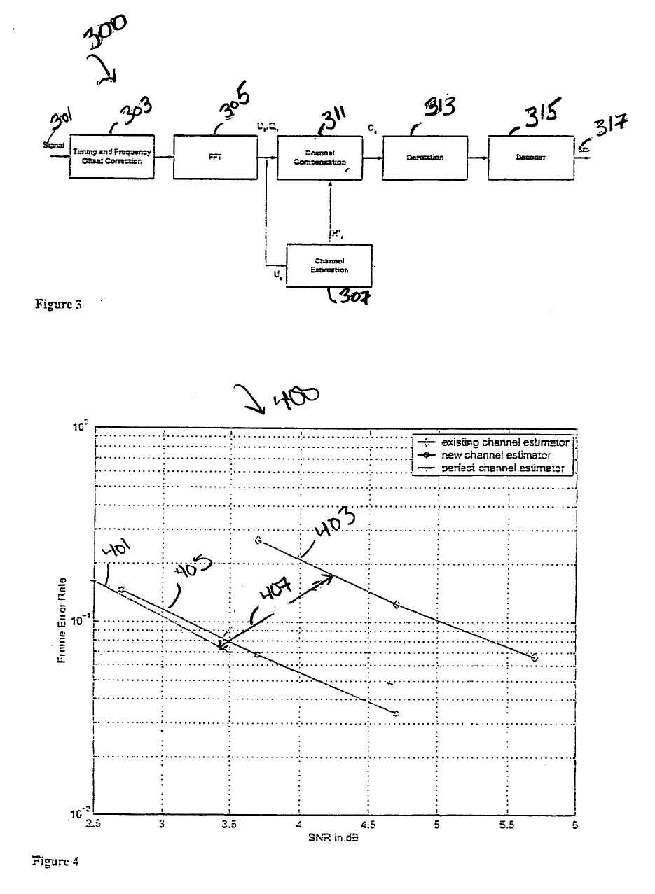

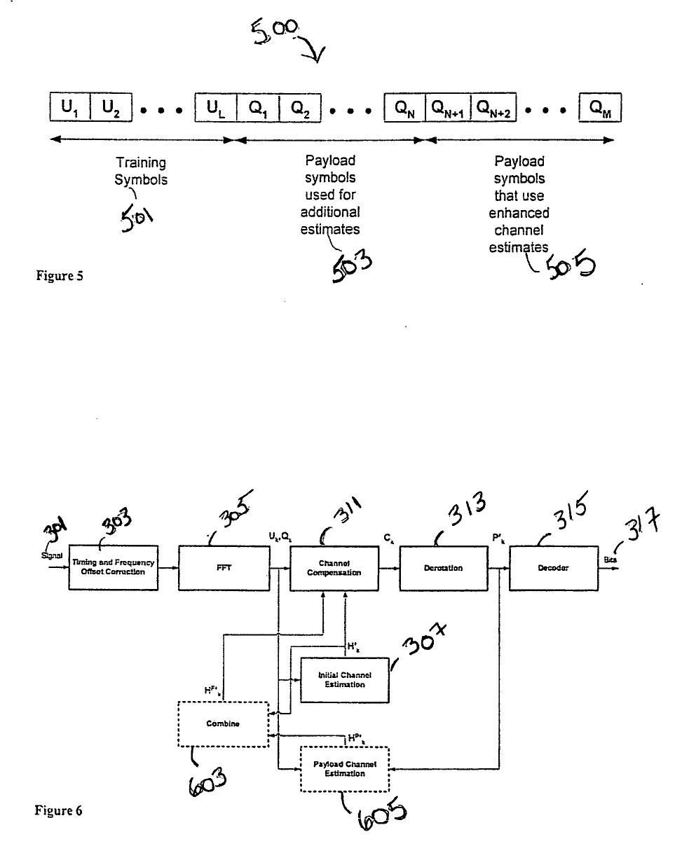

Prior art methods of estimation are typically affected due to noise in the receiver. A packet error rate (PER) versus signal to noise ratio (SNR) curve for the lowest IEEE 802.11 WLAN standard rate, which is 6 Mbps, is plotted for three scenarios in FIG. 4. Note that 802.11 OFDM includes two training symbols for channel estimation and existing systems might, for instance, average the estimate as was previously described. The first scenario, represented by darken line 401, depicts an ideal channel estimator unaffected by receiver noise. The second scenario, marked line 403, represents the PER-SNR curve of the prior art system described above in the background of the invention. As is shown in plot 400 there exists a substantially sized gap 407 in required SNR (henceforth “SNR gap”) between the best possible (“ideal”) system 401 and prior art methods 403. The SNR gap 407 is largely due to noise in the receiver corrupting channel estimates. The third scenario, marked line 405, represents test data obtained with the use of a system which is an embodiment of the current invention, and will be discussed in detail later.

Improving channel estimates beyond the averaging techniques described above, in order to decrease the SNR gap 407, has been attempted. However, existing techniques suffer from various drawbacks. For example existing methods assume knowledge of channel statistics. Knowledge of channel statistics is an unreasonable assumption in the context of, for instance, wireless LANs, wherein the channel may be constantly changing.

Existing methods also often suffer from ‘error floors.’ In a well designed system, the PER should drop as the SNR is increased. However, these schemes display constant PER that does not drop once the SNR is increased beyond a limit. Many existing systems are expensive in terms of hardware and increase system latency, as most existing systems involve matrix manipulations.

Existing systems are also not geared towards the lowest rates of the system. Systems tend to work at their lowest allowable rate at the edge (perimeter) of the network since the lowest rates need the smallest signal strengths to operate reliably. The perimeter of the network is also where multipath is the worst. Hence, multipath performance improvements for the lowest rate translates directly to a larger operating range, which is desired. Currently, no existing system has exploited these attributes.

A method and apparatus for estimation is needed which will overcome the issue of noise and close the SNR gap 407, preferably resulting in a system that provides near ideal results. Certain embodiments also address the lowest rate in the system, which in return improves multipath resilience, allows reception with smaller signal strengths, and allows for a larger operating range. Certain embodiments may also work for any type of linear channel, and will also not suffer from error floors. System latency may be decreased while relying on hardware that is extremely efficient.

An example embodiment of the invention will now be described for the use of 6 Mbps, the lowest 802.11 WLAN OFDM rate. It should be appreciated that while other rates may be employed, the use of lower rates allow for efficient operation. It should be further appreciated that although the invention will be discussed using channel estimates and channel compensation as an example, other estimates and compensations may be employed. Channel estimates are aimed towards compensating for loss obtained by the signal traveling through a transmission channel. It should be appreciated that any transmission channel may be used; for example fibers, coaxial cables, or air.

As an overview, an initial estimate is obtained using the training symbols 501 of the OFDM packet, with the initial channel estimator 307. The first N symbols of the payload 503, as shown in FIG. 5, are used to obtain a payload channel estimate. The initial estimate and the payload estimate are then combined to form a final estimate. The final channel estimation is then applied to the remaining N+1 though M payload symbols, while the first N symbols use the conventional channel estimates.

The payload channel estimates are obtained from the payload symbols of the received packet 500. A difficulty in using the payload for channel estimates is that the payload data is not known prior to the transmission of the symbol. Therefore, a method of estimation of the data in the payload has been developed, which will match the actual (transmitted) symbols with a certain probability.

A new payload channel estimate is obtained with every payload symbol by using an estimated payload as if it were the actual payload:
H^{P}′_{n,k}=Q_{n,k}/P′_{n,k} (4)
where n=1 through N, H^{P}′ refers to the channel estimates that result from the payload, Q_{n,k} refers to the received payload symbol, and P′_{n,k} refers to the estimated transmission payload. Since the lowest rate employs binary phase shift keying (BPSK) modulation (also called 2-QAM), P′_{n,k} is of the form ±1, a modem may be able to resolve the ±1 of the payload with a 100% certainty. Hence the division operation above is a mere sign change in hardware, and thus does not add complicated or expensive hardware to the existing system.

The initial estimate H′, of equation (2) and obtained by using initial channel estimation 307, is combined or updated with the new estimates (H^{P}′) yielding a final estimate H^{F}′, as is shown in the equation below:

$${H}_{k}^{F ,} = \frac{1}{L + N} ( {LH}_{k}^{′} + {\sum }_{n = 1}^{N} {H}_{n , k}^{P ,} ) \qquad ( 5 )$$

Here, the initial estimation obtained using the training symbols, H′ₖ, is multiplied by the total number of training symbols L, and is then added to the sum of the new channel estimate, H^{P}′, obtained with payload symbols 1 though N. The obtained sum is then divided by the total number of training and a first portion of payload symbols L+N. If L is chosen to be a power of two, the realization of equation (5) may be achieved by simple additions and shifts, therefore avoiding the addition of complex or expensive hardware components. Furthermore, if the system is designed such that the sum of L+N is a power of two, the division is reduced to a mere shifting to the right in hardware.

As was previously mentioned, for the first N payload symbols, the initial channel estimate H′ is used in the channel compensation block. After the first N symbols have been compensated, the refined channel estimate H^{F}′ is used for the remaining payload symbols N+1 through M:
Cₖ=Qₖ/H^{F}′ₖ (6)
where k=N+1 though M, and Cₖ corresponds to the OFDM signals that have been compensated. The use of the H^{F}′ estimate needs no significant hardware. What is needed is to merely load in new coefficients in the channel compensation block 311.

Two prerequisites exist in order for the above described invention to work efficiently for lower rates. First, N should be large enough that the averaging advantage of the new (payload based) channel estimates closes the gap between the final channel estimate and the perfect channel estimate 401. Second, the ratio (M−N)/N should be large enough so that the error rate is dominated by the part of the payload that has been compensated by the enhanced channel estimate (H^{F}′), payload symbols N+1 through M, and not by that which uses the initial channel estimate (H′), or payload symbols 1 though N.

There are also considerations which must be put into account when determining the value of N. A small N allows more payload symbols to benefit from the new estimate (H^{F}′). A large N allows the refined channel estimate (H^{P}′) to be closer to perfect. It is possible to calculate the optimal value of N theoretically. Although, a value of N may easily be obtained through experimentation, since L+N should be ideally a power of two, this reduces the choices of N that one has to search through.

As an example, consider a 802.11 WLAN, with transmission control protocol (TCP) data packets roughly 1500 bytes in length. 6 Mbps carries 3 bytes per OFDM symbol, therefore M is close to 500 (1500/3). In this standard L=2 (for the purpose of multipath training). Hence, even if we pick N=30 (so as to make L+N=32, a power of two), the ratio (M−N)/N would be approximately equal to 16, which is a large ratio as is recommended.

The efficacy of the provided example is illustrated in FIG. 4 as curve 405. The data points obtained by the presented invention greatly closes the SNR gap 407 and is much closer to performance obtained via a perfect channel estimator 401 when compared to prior art methods 403. As may be seen in plot 400, curve 407 shows that one embodiment of the presented invention provides performance which is <0.2 dB worse than the best possible 401.

While this invention has been particularly shown and described with references to preferred embodiments thereof, it will be understood by those skilled in the art that various changes in form and details may be made therein without departing from the scope of the invention encompassed by the appended claims. For example, any data rate may be employed. In the employment of other data rates, it should be realized that the hardware operations may cease to be trivial. For instance, true complex division might be needed to estimate the channel from the payload. In addition, the number of symbols may be smaller, or roughly proportional to the inverse of the rate, thus the scheme may be further away from the ideal estimator 401.

What is claimed is:

1. A receiving apparatus to provide a final estimation of OFDM symbols comprising:
a first estimator, the first estimator estimating impairments in a received training symbol; and
a second estimator, the second estimator estimating impairments in a first portion of a received payload symbol.

2. The receiving apparatus of claim 1 further comprising:
an updating estimator, the updating estimator combining the estimations of the first and the second estimators to yield a final estimation.

3. The receiving apparatus of claim 2 further comprising:
a compensator, wherein the first portion of the received payload symbol is compensated using an estimation obtained by the first estimator, and a second portion of the received payload symbols is compensated using the final estimation.

4. The receiving apparatus of claim 1, wherein the lowest 802.11 WLAN OFDM rate of 6 Mbps is used.

5. The receiving apparatus of claim 1, wherein an impairment is channel loss resulting from a transmission channel.

6. The receiving apparatus of claim 1, wherein a size of the first portion of payload symbols is chosen such that a final SNR performance is less than 0.2 dB from ideal performance.

7. The receiving apparatus of claim 3, wherein an error rate is dominated by the second portion of the payload symbols.

8. A method for providing a final estimation of OFDM symbols comprising:
estimating impairments in a received training symbol by obtaining a first estimation; and
estimating impairments in a first portion of a received payload symbol, by obtaining a second estimation.

9. The method of claim 8, further comprising:
calculating the final estimation based on a combination of the first and second estimations.

10. The method of claim 9, further comprising:
compensating the first portion of the received payload symbol using the first estimation; and
compensating a second portion of the received payload symbols using the final estimation.

11. The method of claim 8, wherein the lowest 802.11 WLAN OFDM rate of 6 Mbps is used.

12. The method of claim 8, wherein the impairments are channel loss resulting from a transmission channel.

13. The method of claim 8, wherein a size of the first portion of payload symbols is chosen such that a final SNR performance is less than 0.2 dB from ideal performance.

14. The method of claim 10, further comprising an error rate is dominated by the second portion of the payload symbols.

15. A receiving apparatus to provide a final estimation of OFDM symbols comprising:
a first estimation means for estimating impairments in a received training symbol by obtaining a first estimation; and
a second estimation means for estimating impairments in a first portion of a received payload symbol by obtaining a second estimation.

16. The receiving apparatus of claim 15, further comprising:
an updating estimation means for combining the first and second estimations to yield the final estimation.

17. The receiving apparatus of claim 16, further comprising:
a compensation means for compensation the first portion of the received payload symbol by using the first estimation and for compensating a second portion of the received payload symbols by using the final estimation.

18. A receiving apparatus to provide a final estimation of OFDM symbols comprising:
a first estimator, the first estimator estimating impairments in a received training symbol;
a second estimator, the second estimator estimating impairments in a first portion of a received payload symbol;
an updating estimator, the updating estimator combining the estimations of the first and the second estimators to yield a final estimation; and a compensator, wherein the first portion of the received payload symbol is compensated using an estimation obtained by the first estimator, and a second portion of the received payload symbols is compensated using the final estimation.
